(19) United States
(12) Patent Application Publication
(10) Pub. No.: US 2007/0200825 A1
(43) Pub. Date: Aug. 30, 2007

(54) Mouse device and audio playback system

(76) Inventor: Hiroyuki Ashida, Ukyo-Ku (JP)

Correspondence Address: CANTOR COLBURN, LLP, 55 GRIFFIN ROAD SOUTH, BLOOMFIELD, CT, 06002, US

(21) Appl. No.: 11/709,493

(22) Filed: Feb. 22, 2007

(30) Foreign Application Priority Data
Feb. 24, 2006 (JP) JP2006-048683

(51) Int. Cl. G09G 5/08

(52) U.S. Cl. 345/163

(57) ABSTRACT

A mouse device includes a USB transceiver, an MP3 decoder, and an FM transmitter. The USB transceiver receives the audio data S(MP3), which is audio data that has been compressed in the MP3 format, from a computer, and outputs the audio data to the MP3 decoder. The MP3 decoder decodes the audio data S(MP3), thereby converting the audio data S(MP3) into an analog signal. The FM transmitter converts the analog signal into a radio frequency signal, and transmits the radio frequency signal thus converted to an audio playback device.

### BACKGROUND OF THE INVENTION

1. Field of the Invention

The present invention relates to a mouse device connected to a computer in a wired manner or a wireless manner.

2. Description of the Related Art

In recent years, it has become common to download audio data via the Internet. The audio data thus downloaded is stored on a computer hard disk or the like. With such an arrangement, in order to output high volume/high quality sound according to the audio data thus stored in the computer, there is a need to provide additional equipment in the form of peripheral devices of the computer such as an amplifier and speakers.

### [Patent Document 1]

Japanese Patent Application Laid-Open No. S64-1021

However, such additional peripheral devices of a computer such as an amplifier and speakers, which are necessary for outputting high volume/high quality sound, are undesirable from the perspective of costs and the area required for installation.

### SUMMARY OF THE INVENTION

The present invention has been made in view of such a situation. Accordingly, it is a general purpose of the present invention to provide a technique using a configuration with a reduced number of computer peripheral devices for sound reproduction according to audio data stored in a computer.

In order to solve the aforementioned problems, an embodiment of the present invention relates to a mouse device connected to a computer. The mouse device comprises: a receiver which receives audio data from the computer; and a wireless transmitter which transmits the audio data which has been received from the receiver and which has been converted so as to be in the form of a radio frequency signal for wireless communication.

The computer and the mouse may be connected to each other in a wired manner or a wireless manner. Also, the audio data may be provided in the form of a digital signal or an analog signal.

With such an arrangement, a radio frequency signal, which has been created based upon the audio data, is transmitted from the wireless transmitter. Such an arrangement allows an audio playback device separate from the peripheral devices of the computer to output audio data in the form of sound, which has been reproduced from the radio frequency signal. This allows devices which have a function of outputting high volume/high quality sound according to the audio data than does the computer to be employed as such an audio playback device. Such an arrangement enables the audio data stored in the computer to be output in the form of sound without increasing the number of the peripheral devices of the computer.

Also, the wireless transmitter may include: a stereo modulation unit which converts the audio data into a stereo composite signal, and which outputs the stereo composite signal thus converted; and a frequency modulation unit which executes frequency modulation based upon the stereo composite signal output from the stereo modulation unit. With such an arrangement, it is sufficient for the audio playback device only to output sound according to the audio data reproduced from the radio frequency signal subjected to frequency modulation. Such an arrangement allows various kinds of audio playback devices to reproduce the audio data.

Also, the audio data may be a digital signal coded in a predetermined format. Also, a decoder which decodes the audio data may be further included between the receiver and the wireless transmitter. The term “a predetermined format” as used here represents a compression format such as the MP3 (MPEG Audio Layer-3) format etc., or a method that supports error detection, such as CRC (Cyclic Redundancy Check) or the like, for example. With such an arrangement, the audio data is provided in the form of a digital signal, thereby suppressing signal noise in the overall system between the computer and the mouse device.

The mouse device may have a configuration such that it can be connected to the computer via a USB (Universal Serial Bus) cable. With such an arrangement, the mouse device is compatible with the common USB standard, thereby broadening the range of use of the mouse device.

The wireless transmitter may transmit the radio frequency signal using an antenna provided integrally with the USB cable. With such an arrangement, the wiring that connects the computer and the mouse device also serves as a transmission antenna, thereby providing an effective use of the wiring.

The components of the wireless transmitter may be integrally formed on a single semiconductor substrate. Examples of “components integrally formed” as used here include: an arrangement in which all the components of a circuit are formed on a semiconductor substrate; and an arrangement in which principal components of a circuit are integrally formed on a semiconductor substrate, and a part comprising resistors and capacitors for adjusting the circuit constants is provided externally to the semiconductor substrate. With such an arrangement, the components are integrally formed on a single semiconductor substrate, thereby allowing the wireless transmitter to be mounted on a mouse device in a simple manner.

Another embodiment of the present invention relates to an audio playback system. The audio playback system comprises: a computer which transmits audio data; a mouse device which is connected to the computer, and which receives the audio data; and an audio playback device which outputs sound according to a radio frequency signal received from the mouse device.

With such an embodiment, the audio playback device may have a function of outputting sound reproduced from the radio frequency signal. With such an arrangement, a device other than the peripheral devices of the computer may be employed as the audio playback device. For example, an audio player, which has been provided in the vicinity of the computer, may be employed as the audio playback device. Such an arrangement allows the audio data stored in the computer to be output in the form of sound without increasing the number of the peripheral devices of the computer.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic diagram which shows an overall configuration of an audio playback system according to an embodiment;

FIG. 2 is a block diagram which shows a configuration of a mouse device shown in FIG. 1;

FIG. 3 is a block diagram which shows a configuration of an FM transmitter shown in FIG. 2; and

FIG. 4 is a functional block diagram which shows a configuration of a computer shown in FIG. 1.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

An embodiment relates to an audio playback system in which audio data stored in a computer is transmitted, after high-frequency conversion, in the form of a radio frequency signal via wireless communication, and sound is reproduced from the radio frequency signal via an audio playback device provided separately from the computer peripheral devices.

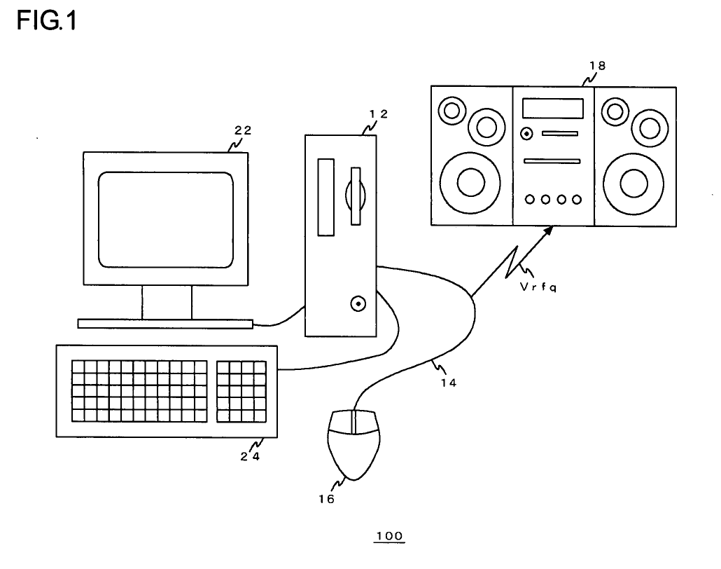

FIG. 1 is an overall configuration of an audio playback system 100 according to an embodiment.

The audio playback system 100 comprises a computer 12, a USB cable 14, a mouse device 16, an audio playback device 18, a display 22, and a keyboard 24.

The computer 12 stores audio data compressed in the MP3 format. The mouse device 16 is formed according to the USB standard, and is connected to the computer 12 via the USB cable 14. The mouse device 16 converts the audio data received from the computer 12 via the USB cable 14 into a radio frequency signal Vrfq, and transmits the radio frequency signal Vrfq to the audio playback device 18. In FIG. 1, the radio frequency signal Vrfq is transmitted via an antenna provided integrally with the USB cable 14. Detailed description will be made later regarding the configuration and the operation of the mouse device 16.

The audio playback device 18 includes an FM (Frequency Modulation) tuner and a stereo decoder (not shown). With such an arrangement, the audio playback device 18 serially executes frequency demodulation and stereo demodulation of the radio frequency signal Vrfq received from the mouse device 16, and outputs sound reproduced from the radio frequency signal Vrfq. The audio playback device 18 is an audio player provided in the vicinity of the computer 12 and separately from the peripheral devices of the computer 12, for example. A display 22 displays information necessary for the user of the computer. A keyboard 24 is connected to the computer 12, which serves as an input device.

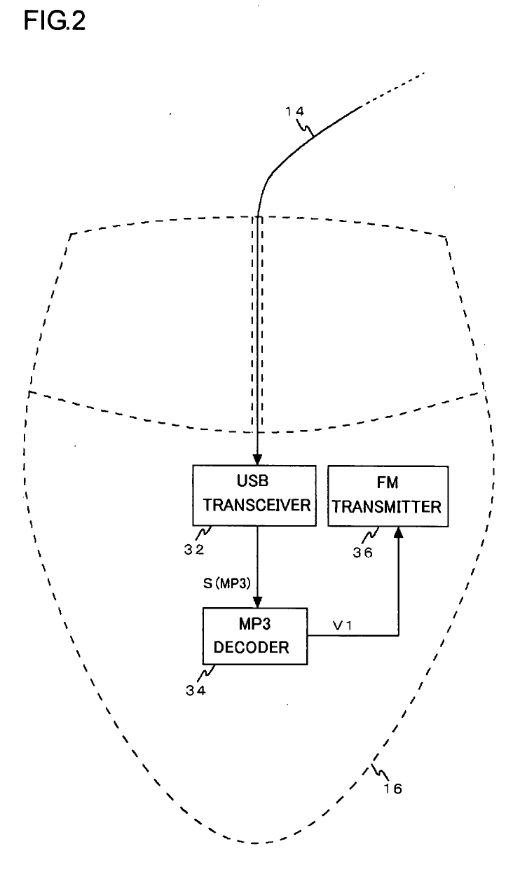

FIG. 2 shows a configuration of the mouse device 16.

The mouse device 16 comprises a USB transceiver 32, an MP3 decoder 34, and an FM transmitter 36.

The USB transceiver 32 receives audio data S(MP3) compressed in the MP3 format from the computer 12 shown in FIG. 1, and outputs the audio data S(MP3) to the MP3 decoder 34. The MP3 decoder 34 decodes the audio data S(MP3), thereby converting the audio data S(MP3) into an analog signal V1. The FM transmitter 36 converts the analog signal V1 into a radio frequency signal Vrfq, and transmits the radio frequency signal Vrfq to the audio playback device 18 shown in FIG. 1.

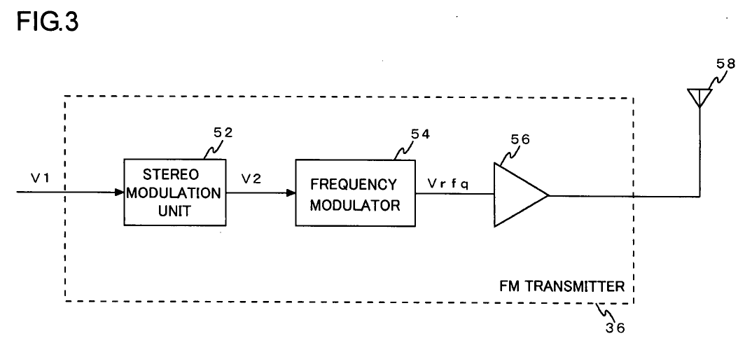

FIG. 3 shows a configuration of the FM transmitter 36 shown in FIG. 2. Note that circuit blocks such as filters and so forth are not shown in FIG. 3.

The FM transmitter 36 includes a stereo modulation unit 52, a frequency modulator 54, and a power amplifier 56. These components of the FM transmitter 36 may be integrally provided in the form of a single LSI (Large Scale Integration). Also, these components may be provided in the form of separate ICs (Integrated Circuits).

The stereo modulation unit 52 converts the analog signal V1 output from the MP3 decoder 34 shown in FIG. 2 into a stereo composite signal V2, and outputs the stereo composite signal V2 to the frequency modulator 54. The frequency modulator 54 executes frequency modulation of the stereo composite signal V2, and outputs the radio frequency signal Vrfq. The radio frequency signal Vrfq is amplified by the power amplifier 56, and is transmitted to the audio playback device 18 shown in FIG. 1 via the antenna 58. The antenna 58 is provided integrally with the USB cable 14.

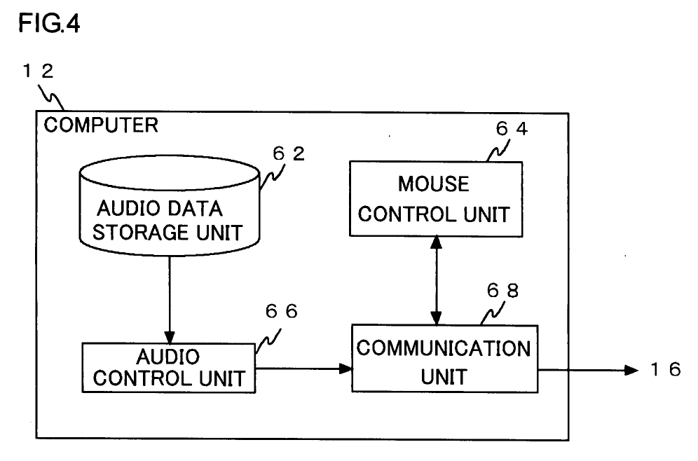

FIG. 4 shows a configuration of the computer 12 shown in FIG. 1. These components shown in FIG. 4 in the form of functional blocks that provide various processing can be realized by hardware means, e.g., by actions of a CPU, memory, and other LSIs, or by software means, e.g., by actions of a program having a function of reservation management loaded into the memory. Accordingly, such functional blocks can be realized by hardware components alone, software components alone, or various combinations thereof, which can be readily conceived by those skilled in this art. That is to say, each functional block is not restricted to hardware components alone or software components alone.

The computer 12 includes an audio data storage unit 62, a mouse control unit 64, an audio control unit 66, and a communication unit 68. The mouse control unit 64 has the functions of a typical mouse device driver. Specifically, the mouse control unit 64 converts the input received from the mouse device 16 that serves as an input device into the movement of a cursor displayed on the display 22 shown in FIG. 1, for example. The communication unit 68 provides communication between the computer 12 and the mouse device 16.

The audio data storage unit 62 comprises a hard disk, for example, and stores audio data compressed in the MP3 format. The audio control unit 66 acquires the audio data thus held by the audio data storage unit 62, and transmits the audio data to the mouse device 16 via the communication unit 68.

Description will be made regarding the operation of the audio playback system 100 having such a configuration as described above.

Upon performance of a predetermined operation by the user via the computer 12, the computer 12 is instructed to reproduce sound according to the audio data compressed in the MP3 format. Upon the computer 12 being instructed to output sound, the audio data stored in the computer 12 itself is transmitted to the mouse device 16 via the USB cable 14.

The USB transceiver 32 of the mouse device 16 receives the audio data thus transmitted. The MP3 decoder 34 of the mouse device 16 performs decoding processing corresponding to the MP3 format for the audio data thus received, thereby creating an analog signal V1. The FM transmitter 36 of the mouse device 16 converts the analog signal V1 into a stereo composite signal V2, and performs frequency modulation based upon the stereo composite signal V2, thereby creating a radio frequency signal Vrfq. The radio frequency signal Vrfq thus created is transmitted to the audio playback device 18 via the antenna 58 provided integrally with the USB cable 14. The audio playback device 18 serially performs frequency demodulation and stereo demodulation of the radio frequency signal Vrfq thus transmitted, and outputs sound reproduced from the radio frequency signal Vrfq.

With the present embodiment, the mouse device 16 converts the audio data stored in the computer 12 into the radio frequency signal Vrfq for wireless communication. Such an arrangement enables the audio playback device 18 provided in the vicinity of the computer 12, which is a separate device from the peripheral devices of the computer 12, to output sound according to the audio data. A conventional audio player may be employed as the audio playback device 18. This enables high volume/high quality sound to be output according to the audio data stored in the computer 12 without increasing the number of peripheral devices of the computer 12.

On the other hand, the radio frequency signal Vrfq is generated by frequency modulation by the FM transmitter 36. Accordingly, it is sufficient for the audio playback device 18 only to be able to reproduce sound based upon the signal thus subjected to the frequency modulation. This enables various kinds of devices to be employed as the audio playback device 18. Thus, the range of use of the mouse device 16 can be broadened. At the same time, this makes it easier for the user to start to use the audio playback system 100. Furthermore, the audio data is transmitted from the computer 12 to the mouse device 16 via the USB cable 14 in the form of a digital signal, thereby suppressing signal noise.

Furthermore, the MP3 decoder 34 is included within the mouse device 16, thereby improving the ease-of-use of the mouse device 16. That is to say, the mouse device 16 can handle both the audio data received in the MP3 format and the audio data received in the form of a stereo signal after demodulation, thereby broadening the range of use of the mouse device 16.

Furthermore, the mouse device 16 is formed according to the common USB standard, thereby broadening the range of use of the mouse device 16. Furthermore, the antenna 58, which is employed as an antenna of the FM transmitter 36 as shown in FIG. 3, is provided integrally with the USB cable 14 shown in FIG. 1. Such an arrangement provides an effective use of the wiring that connects the computer 12 and the mouse device 16. This simplifies the configuration of the audio playback system 100.

The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

Description has been made in the aforementioned embodiment regarding an arrangement in which the audio data stored in the computer 12 is the target (which will be referred to as “target data” hereafter) which, after conversion, is to be transmitted from the mouse device 16 in the form of a radio frequency signal Vrfq. However, the target data is not restricted to such audio data. That is to say, the target data is not restricted to the audio data stored on a hard disk, which is included in the computer 12 or is provided externally to the computer 12, or an external storage medium such as a CD, DVD, etc. Also, the target data may be the audio data temporarily stored in main memory of the computer 12. Also, the mouse device 16 may include a stereo jack. With such an arrangement, the target data may be the audio data input via stereo jack from a device other than the computer 12. Such an arrangement improves the ease-of-use of the mouse device 16.

Description has been made in the aforementioned embodiment regarding the mouse device 16 having a decoding function corresponding to the MP3 format, a function of stereo modulation, and a function of frequency modulation. Also, an arrangement may be made in which the computer 12 provides a decoding function corresponding to the MP3 format. With such an arrangement, there is no need to provide the MP3 decoder 34 to the mouse device 16, thereby simplifying the configuration of the mouse device 16. Also, the computer 12 may provide a function of stereo modulation. With such an arrangement, there is no need to provide the stereo modulation unit 52 to the FM transmitter 36, thereby simplifying the configuration of the mouse device 16.

Description has been made in the aforementioned embodiment regarding an arrangement in which the audio data is stored in the computer 12 in the form of compressed audio data in the MP3 format. However, the coding format for the audio data is not restricted to the MP3 format. Also, various formats may be employed. Also, the audio data may be stored as uncompressed data. The audio data may be coded using a method that supports error detection and correction such as CRC or the like, instead of or in addition to being compressed. Such an arrangement suppresses deterioration in data precision due to noise occurring in audio data transmission from the computer 12 to the mouse device 16.

Description has been made in the aforementioned embodiment regarding an arrangement in which the MP3 decoder 34 decodes the audio data in the form of an analog signal, and the FM transmitter 36 transmits the audio data, after analog modulation, to the audio playback device 18 in the form of a radio frequency signal Vrfq. However, the present invention is not restricted to such an arrangement. A digital modulation method may be employed as the modulation method for the FM transmitter 36.

Description has been made in the aforementioned embodiment regarding an arrangement in which the antenna 58 used for the FM transmitter 36 of the mouse device 16 is provided integrally with the USB cable 14. However, the present invention is not restricted to such an arrangement. The antenna 58 may be provided separately from the USB cable 14. Also, the antenna 58 may be provided in the form of a built-in antenna included in the mouse device 16. This improves the degree of freedom available with respect to the design of the mouse device 16.

Description has been made in the aforementioned embodiment regarding an arrangement in which the mouse device 16 is formed according to the USB standard, and is connected to the computer 12 via the USB cable 14. However, the present invention is not restricted to such an arrangement. A PS/2 mouse may be employed as the mouse device 16. With such an arrangement employing a PS/2 mouse, the mouse device 16 is connected to the computer 12 via a PS/2 interface. Also, the mouse device 16 may be connected to the computer 12 via wireless communication. This improves the degree of freedom available with respect to the design of the mouse device 16.

Description has been made in the aforementioned embodiment regarding an arrangement in which the audio playback device 18 outputs sound reproduced from the radio frequency signal Vrfq transmitted from the FM transmitter 36. Also, the audio playback device 18 may store the radio frequency signal Vrfq thus demodulated, in addition to or instead of outputting the audio data in the form of sound. That is to say, the audio playback device 18 may be a storage/reproduction device or a storage device. This broadens the range of use of the audio playback system 100.

While the preferred embodiments of the present invention have been described using specific terms, such description is for illustrative purposes only, and it is to be understood that changes and variations may be made without departing from the spirit or scope of the appended claims.

What is claimed is:

1. A mouse device connected to a computer, said mouse device comprising:
a receiver which receives audio data from the computer; and
a wireless transmitter which transmits the audio data which has been received from said receiver and which has been converted so as to be in the form of a radio frequency signal for wireless communication.

2. A mouse device according to claim 1, wherein said wireless transmitter includes:
a stereo modulation unit which converts the audio data into a stereo composite signal, and which outputs the stereo composite signal thus converted; and
a frequency modulation unit which executes frequency modulation based upon the stereo composite signal output from said stereo modulation unit.

3. A mouse device according to claim 1, wherein the audio data is a digital signal coded in a predetermined format,
and wherein a decoder which decodes the audio data is further included between said receiver and said wireless transmitter.

4. A mouse device according to claim 1, which has a configuration such that it can be connected to the computer via a USB (Universal Serial Bus) cable.

5. A mouse device according to claim 4, wherein said wireless transmitter transmits the radio frequency signal using an antenna provided integrally with said USB cable.

6. A mouse device according to claim 1, wherein components of said wireless transmitter are integrally formed on a single semiconductor substrate.

7. An audio playback system comprising:
a computer which transmits audio data;
a mouse device which is connected to said computer, and which receives the audio data; and
an audio playback device which outputs sound according to a radio frequency signal received from said mouse device,
wherein said mouse device comprises:
a receiver which receives the audio data from said computer; and
a wireless transmitter which converts the audio data received by said receiver into a radio frequency signal for wireless communication, and which transmits the radio frequency signal thus converted.
